(19) United States
(12) Patent Application Publication
(10) Pub. No.: US 2019/0070992 A1
(43) Pub. Date: Mar. 7, 2019

(54) Floor Mat With Interchangeable Functional Inserts

(71) Applicant: Thomas P. Macauda, Downers Grove, IL (US)

(72) Inventor: Thomas P. Macauda, Downers Grove, IL (US)

(21) Appl. No.: 16/123,951

(22) Filed: Sep. 6, 2018

Related U.S. Application Data
(60) Provisional application No. 62/554,948, filed on Sep. 6, 2017.

(51) Int. Cl. B60N 3/04

(52) U.S. Cl. CPC B60N 3/048; B60N 3/044

(57) ABSTRACT

A vehicle floor mat can include a base that conforms to the contour of a vehicle floor and has one or more receptacles formed in the upwardly facing surface of the base. An insert can be received and retained within the receptacle. The receptacles can include a gasket strip that overlaps the perimeter of an insert placed into the receptacle to create a water resistant seal. In some embodiments, the insert, can have electrically powered functionality and can be removable from and replaceable within the receptacle. A source of electric power and conductors can supply the electric power to the insert. In at least some embodiments, the floor mat can include at least one manipulatable switch capable of connecting and disconnecting the electric power to and from the insert. In some or the same embodiments, the floor mat can include a microprocessor-based receiver/transmitter capable of receiving and transmitting signals wirelessly from and to a user device, such as a smart phone. The signals actuate and control the electrically powered functionality associated with the insert.

### CROSS-REFERENCE TO RELATED APPLICATION

This application claims priority benefits from U.S. provisional patent application Ser. No. 62/554,948 filed on Sep. 6, 2017, entitled “Floor Mat With Interchangeable Functional Inserts”. The '948 application is hereby incorporated by reference herein in its entirety.

### FIELD OF THE INVENTION

The present invention relates to floor mats and, in particular, to floor mats with interchangeable inserts having functionality such as ease of cleaning, vibration and temperature variation.

### BACKGROUND OF THE INVENTION

Floor mats are designed to protect the underlying surface from dirt, wear and corrosion. More importantly, floor mats provide a surface that is less slippery than the underlying surface, thereby providing a safer surface on which to walk.

Vehicle mats, also referred to as automobile floor mats, are designed to protect a vehicle's floor from dirt, wear and corrosion, particularly from road salt and other chemical substances that could deteriorate the carpeted surface originally installed on the vehicle floor. In addition, the clothing and footwear of passengers could be detrimentally affected by the presence of road salt and other chemicals adsorbed in the vehicle floor carpet.

One major use of a vehicle mat is to keep the car looking clean. Most mats can be easily removed for cleaning and then replaced. Some require fixation points to ensure they remain fixed in position. Vehicle floor mats often feature spikes, grooves, or caps to capture dirt and water, and are most often made from synthetic rubber, other moldable plastic material and/or textile materials.

Vehicle mats are an interior accessory that are generally included with the purchase of a vehicle. However, many car owners choose to upgrade their vehicle mats, particularly with thicker and more durable mats that are better customized to fit the contours of the floor of a particular vehicle. Vehicle mats are generally offered in two options: rubber or carpet fabric. Carpet mats are generally tufted, provide a cushioned surface, and have a rubberized anti-slip backing, while rubber mats are heavier duty, easier to clean and more durable.

Safety features are common in rubber mats; for example, an anti-slip bottom side and a heel pad for added safety and wear. Aesthetic features are also common in floor mats, including colorization of their rubber and textile materials, and also including branded company logos, cartoon characters and/or advertisements.

Apart from safety and aesthetic features, vehicle and indoor building surface floor mats lack many other functional features that can enhance their use. Passive functionality, such as ease of removal of sections of the mat for cleaning and surfaces within the mat that provide a pleasing tactile experience, can be incorporated into floor mats. Active functionality, such as vibration and temperature variation can also be incorporated into floor mats to enhance drivers' and passengers' driving experience.

### SUMMARY OF THE INVENTION

Shortcomings of existing, conventional floor mats are overcome by a floor mat comprising:
(a) a base having at least one receptacle formed in the upwardly facing surface of said base;
(b) at least one insert configured to be received and retained within said receptacle, said at least one insert removable from and replaceable within said at least one receptacle; and
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle.

In some embodiments of the foregoing floor mat, the at least one receptacle can be a pair of receptacles and the at least one insert can be a pair of inserts. Each of the inserts can be configured to be received and retained within one of the receptacles. The insert can be formed of a porous material capable of being penetrated by a pressurized fluid to flush out extraneous material accumulated on or within the pores of the insert. The porous material can be a mesh.

Shortcomings of existing, conventional vehicle floor mats are overcome by a vehicle floor mat comprising:
(a) a base having an outwardly-facing perimeter surface configured to conform to the contour of the vehicle floor, the base having at least one receptacle formed in the upwardly facing surface of the base; and
(b) at least one insert configured to be received and retained within the receptacle, the at least one insert removable from and replaceable within the at least one receptacle, the at least one insert having electrically powered functionality associated therewith;
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle;
(d) a source of electric power and conductors to supply the electric power to the at least one insert; and
(e) at least one manipulatable switch capable of connecting and disconnecting the electric power to and from the at least one insert.

In some embodiments of the foregoing vehicle floor mat, the at least one receptacle can be a pair of receptacles and the at least one insert can be a pair of inserts. Each of the inserts can be configured to be received and retained within one of the receptacles. The at least one manipulatable switch can be a pair of manipulatable switches, each of the switches being capable of connecting and disconnecting the electric power to and from one of the inserts

Shortcomings of existing, conventional vehicle floor mats are also overcome by a vehicle floor mat comprising:
(a) a base having an outwardly-facing perimeter surface configured to conform to the contour of the vehicle floor, the base having at least one receptacle formed in the upwardly facing surface of the base; and
(b) at least one insert configured to be received and retained within the receptacle, the at least one insert removable from and replaceable within the at least one receptacle, the at least one insert having electrically powered functionality associated therewith;
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle;
(d) a source of electric power and conductors to supply the electric power to the at least one insert; and
(f) a microprocessor-based receiver/transmitter capable of receiving and transmitting signals wirelessly from and to a user device, the signals actuating and controlling the electrically powered functionality associated with the at least one insert.

In some embodiments of the foregoing vehicle floor mats, the electrically powered functionality can be a vibration device, an undulating device, a stimulation device, a heating device, a light-emitting device, and/or a sound-producing device. The light emissions of the light-emitting device can be synchronized with music or other sounds received by the device.

In some embodiments, one or more of the inserts with electrically powered functionality can be removable such that the insert can be employed separately and independently. For example, an insert having electrostimulation functionality could be removed from its installation within the vehicle and used in a home setting, with power being supplied either via battery or alternating current transformer. The present vehicle floor mat can thereby be converted from vehicle to home use and vice versa.

### BRIEF DESCRIPTION OF THE DRAWINGS

FIG. 1 is a perspective view of an illustrative vehicle floor mat with an integral receptacle portion for receiving and retaining an interchangeable functional insert.

FIG. 1A is a cross-sectional view taken in the direction of arrows A-A in FIG. 1.

FIG. 1B is a cross-sectional view taken in the direction of arrows B-B in FIG. 1.

FIG. 2 is a perspective view of an illustrative indoor building surface floor mat with an integral receptacle portion for receiving and retaining an interchangeable functional insert.

FIG. 2A is a cross-sectional view taken in the direction of arrows A-A in FIG. 2.

FIG. 2B is a cross-sectional view taken in the direction of arrows B-B in FIG. 2.

FIG. 3 is a perspective view of an illustrative vehicle floor mat with an integral receptacle portion for receiving and retaining an interchangeable functional insert, in which the inwardly-facing perimeter of the receptacle portion has gasket strip extending inwardly to apply pressure to the insert and retain it within the receptacle.

FIG. 3A is a cross-sectional view taken in the direction of arrows A-A in FIG. 3.

FIG. 3B is a cross-sectional view taken in the direction of arrows B-B in FIG. 3.

FIG. 3C is a cross-sectional view, with an enlarged inset, taken in the direction of arrows A-A in FIG. 3.

FIG. 4 is a perspective view of an illustrative indoor building surface floor mat with an integral receptacle portion for receiving and retaining an interchangeable functional insert, in which the inwardly-facing perimeter of the receptacle portion has gasket strip extending inwardly to apply pressure to the insert and retain it within the receptacle.

FIG. 4A is a cross-sectional view taken in the direction of arrows A-A in FIG. 4.

FIG. 4B is a cross-sectional view taken in the direction of arrows B-B in FIG. 4.

FIG. 4C is a cross-sectional view, with an enlarged inset, taken in the direction of arrows A-A in FIG. 4.

FIG. 5 is a perspective view of an illustrative vehicle floor mat with an integral receptacle portion for receiving and retaining an insert with active functionality actuated by one or more foot switches, the electric power for which is provided by a source from within the vehicle's electric system.

FIG. 6 is a perspective view of an illustrative vehicle floor mat with an integral receptacle portion for receiving and retaining an insert with active functionality actuated by wireless transmission between a microprocessor-based receiver/transmitter and a user device, the electric power for which can be provided by a source from within the vehicle's electric system.

### DETAILED DESCRIPTION OF ILLUSTRATIVE EMBODIMENT(S)

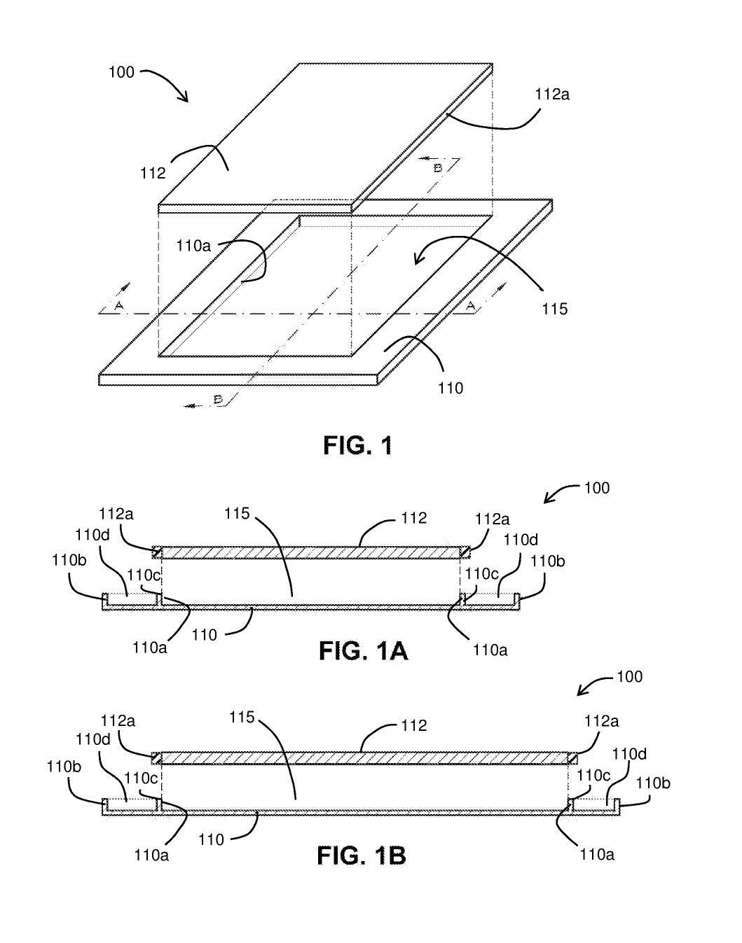

FIG. 1 and corresponding cross-sectional views in FIGS. 1A and 1B depict an illustrative embodiment of a vehicle floor mat 100 with an integral receptacle portion for receiving and retaining an interchangeable functional insert. Floor mat 100 includes base 110 with receptacle 115 formed in the upwardly facing surface of base 110. Receptacle 115 can be formed by inwardly facing wall surface 110a. Insert 112 can be configured to be received and retained within receptacle 115 via a press fit between inwardly facing wall surface 110a and the outwardly facing perimeter surface 112a. As shown by the hatched line in FIGS. 1, 1A and 1B, insert 112 can be removable from and replaceable within receptacle 115.

In the cross-sectional views depicted in FIGS. 1A and 1B, the structure of floor mat base 110 is shown in more detail. As shown, base 110 has an upstanding perimeter wall 110b that conforms to the contour of the vehicle floor on which floor mat 100 can be to be installed. An interior upstanding wall 110c has an inwardly facing wall surface 110a that forms a press fit with outwardly facing perimeter surface 112a. In at least some embodiments, as further shown in FIGS. 1A and 1B, in somewhat exaggerated form, the distance between the oppositely disposed portions of insert perimeter surface 112a can be preferably slightly greater than the distance between the oppositely disposed portions of inwardly facing wall surface 110a so that a durable press fit can be formed.

In some embodiments, the distance between oppositely disposed portions of insert perimeter surface 112a can be the same as the distance between oppositely disposed portions of inwardly facing wall surface 110a such that insert 112 can be inserted or dropped into receptacle 115.

In some embodiments, insert 112 can be configured to be received and retained within receptacle 115 via clips, snaps and/or hook-and-loop fasteners.

In some embodiments, channel 110d can be formed between upstanding walls 110b and 110c. Channel 110d can contain fluids, such as water drawn into the vehicle, as well as liquids like spilled soft drinks, until the fluids are either evaporated or wiped away.

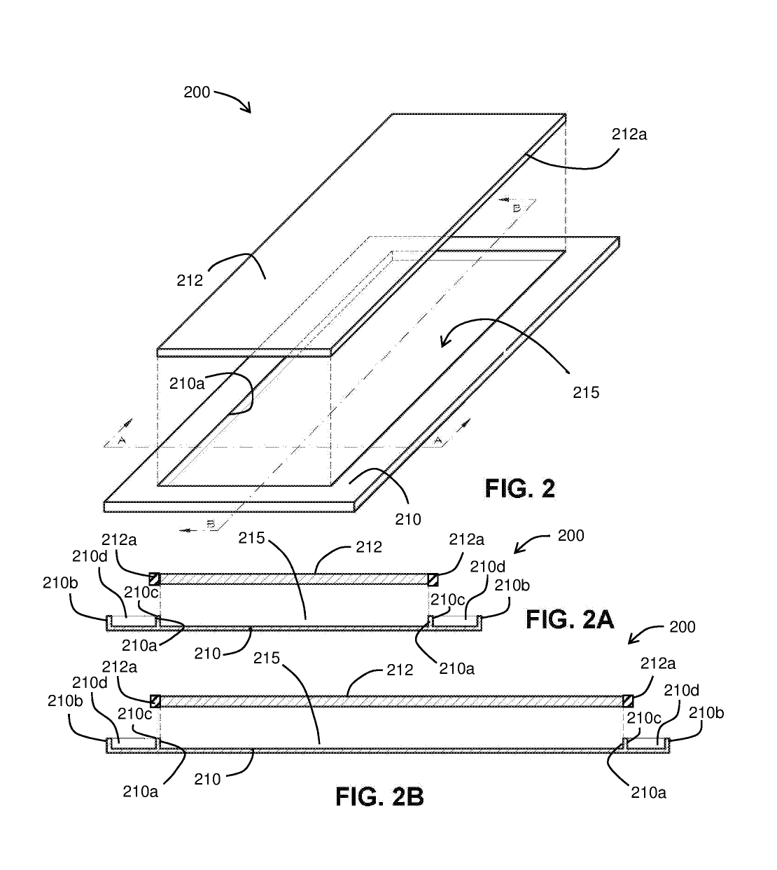

FIG. 2 and corresponding cross-sectional views in FIGS. 2A and 2B depict an illustrative embodiment of indoor building surface floor mat 200 with an integral receptacle portion for receiving and retaining an interchangeable functional insert. Floor mat 200 includes base 210 with receptacle 215 formed in the upwardly facing surface of base 210. Receptacle 215 can be formed by an inwardly facing wall surface 210a. Insert 212 can be configured to be received and retained within receptacle 215 via a press fit between inwardly facing wall surface 210a and outwardly facing perimeter surface 212a. As shown by the hatched line in FIGS. 2, 2A and 2B, insert 212 can be removable from and replaceable within receptacle 215.

In the cross-sectional views depicted in FIGS. 2A and 2B, the structure of floor mat base 210 is shown in more detail. As shown, base 210 has upstanding perimeter wall 210b. An interior upstanding wall 210c has an inwardly facing wall surface 210a that forms a press fit with outwardly facing insert perimeter surface 212a. In at least some embodiments, as further shown in FIGS. 2A and 2B, in somewhat exaggerated form, the distance between the oppositely disposed portions of insert perimeter surface 212a can be preferably slightly greater than the distance between the oppositely disposed portions of inwardly facing wall surface 210a so that a durable press fit can be formed.

In some embodiments, the distance between oppositely disposed portions of insert perimeter surface 212a can be the same as the distance between oppositely disposed portions of inwardly facing wall surface 210a such that insert 212 can be inserted or dropped into receptacle 215.

In some embodiments, insert 212 can be configured to be received and retained within receptacle 215 via clips, snaps and/or hook-and-loop fasteners.

In some embodiments, channel 210d can be formed between upstanding walls 210b and 210c. Channel 210d can contain fluids, such as water spilled onto mat 200, as well as liquids like spilled soft drinks, until the fluids are either evaporated or wiped away.

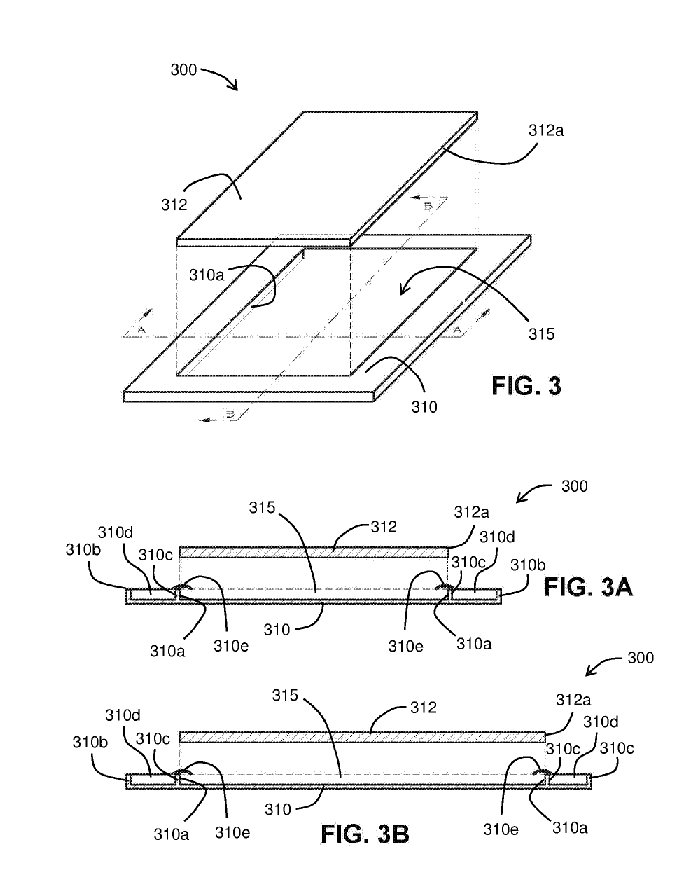

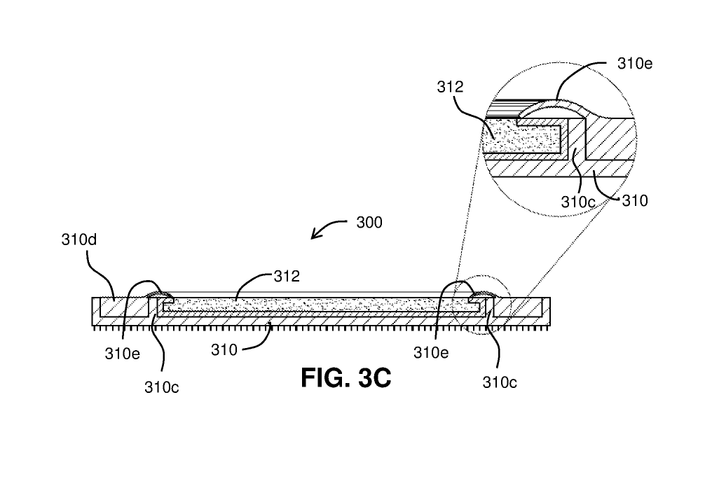

FIG. 3 and corresponding cross-sectional views in FIGS. 3A and 3B depict an illustrative embodiment of a vehicle floor mat 300 with integral receptacle 315 for receiving and retaining an interchangeable functional insert 312. Floor mat 300 includes a base 310 with receptacle 315 formed in the upwardly facing surface of base 310. Receptacle 315 can be formed by inwardly facing wall surface 310a. An insert 312 can be configured to be received and retained within receptacle 315 via a press fit between inwardly facing wall surface 310a and outwardly facing perimeter surface 312a. As shown by the hatched line in FIGS. 3, 3A and 3B, insert 312 can be removable from and replaceable within receptacle 315.

In the cross-sectional views depicted in FIGS. 3A and 3B, the structure of floor mat base 310 is shown in more detail. As shown, base 310 has an upstanding perimeter wall 310b that conforms to the contour of the vehicle floor on which floor mat 300 can be to be installed. An interior upstanding wall 310c can have a gasket strip 310e that extends inwardly to apply downward pressure to insert 312 and retain insert 312 within receptacle 315, thereby supplementing the press fit formed between inwardly facing wall surface 310a and outwardly facing perimeter surface 312a.

An enlarged view of gasket strip 310e is shown in FIG. 3C. In some embodiments, gasket strip 310e can surround the entire perimeter of interior upstanding wall 310c. In addition to applying a downward pressure to insert 312, gasket strip 310e can create a water resistant seal between inwardly facing wall surface 310a and outwardly facing perimeter surface 312a.

In some embodiments, the distance between oppositely disposed portions of outwardly facing perimeter surface 312a can be the same as the distance between oppositely disposed portions of inwardly facing wall surface 310a such that insert 312 can be inserted or dropped into receptacle 315.

In some embodiments, insert 312 can be configured to be received and retained within receptacle 315 via clips, snaps and/or hook-and-loop fasteners.

In some embodiments, channel 310d can be formed between upstanding walls 310b and 310c. Channel 310d can contain fluids, such as water drawn into the vehicle, as well as liquids like spilled soft drinks, until the fluids are either evaporated or wiped away.

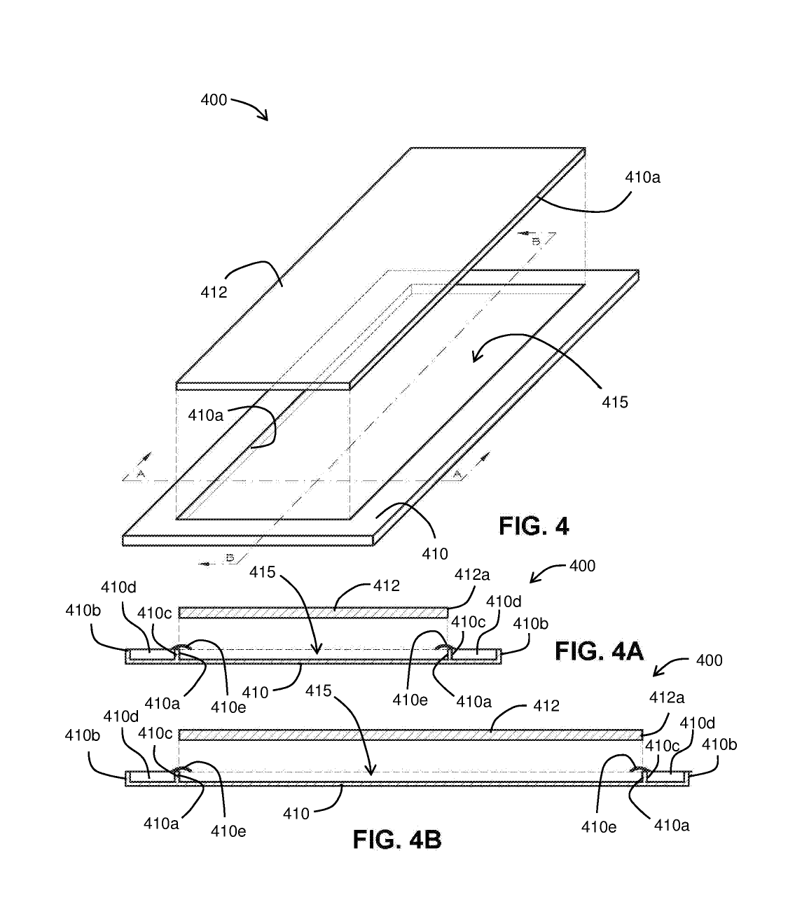

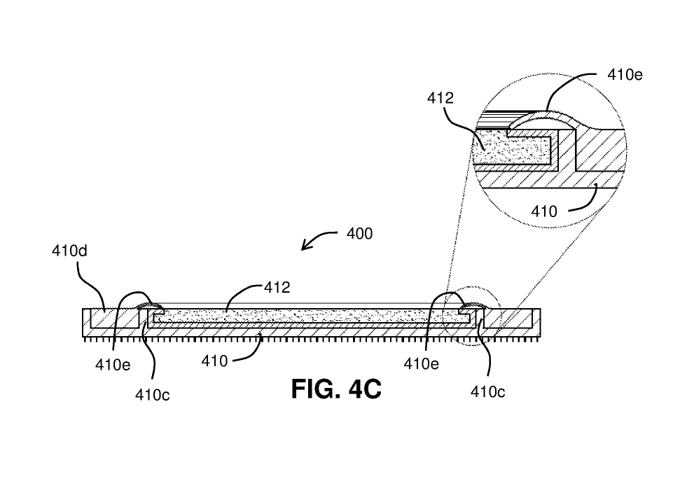

FIG. 4 and corresponding cross-sectional views in FIGS. 4A and 4B depict an illustrative embodiment of an indoor building surface floor mat 300 with integral receptacle 415 for receiving and retaining interchangeable functional insert 412. Floor mat 400 includes base 410 with receptacle 415 formed in the upwardly facing surface of base 410. Receptacle 415 can be formed by an inwardly facing wall surface 410a. An insert 412 can be configured to be received and retained within receptacle 415 via a press fit between inwardly facing wall surface 410a and the outwardly facing perimeter surface 412a. As shown by the hatched line in FIGS. 4, 4A and 4B, insert 412 can be removable from and replaceable within receptacle 415.

In the cross-sectional views depicted in FIGS. 4A and 4B, the structure can be floor mat base 410 can be shown in more detail. As shown, base 410 has an upstanding perimeter wall 410b. An interior upstanding wall 410c has a gasket strip 410e that extends inwardly to apply downward pressure to insert 412 and retain insert 412 within receptacle 415, thereby supplementing the press fit formed between inwardly facing wall surface 410a and outwardly facing insert perimeter surface 412a.

An enlarged view of gasket strip 410e is shown in FIG. 4C. In some embodiments, gasket strip 410e can surround the entire perimeter of interior upstanding wall 410c. In addition to applying a downward pressure to insert 412, gasket strip 410e can create a water resistant seal between inwardly facing wall surface 410a and outwardly facing perimeter surface 412a.

In some embodiments, the distance between oppositely disposed portions of outwardly facing perimeter surface 412a can be the same as the distance between oppositely disposed portions of inwardly facing wall surface 410a such that insert 412 can be inserted or dropped into receptacle 415.

In some embodiments, insert 412 can be configured to be received and retained within receptacle 415 via clips, snaps and/or hook-and-loop fasteners.

In some embodiments, channel 410d can be formed between upstanding walls 410b and 410c. Channel 410d can contain fluids, such as water spilled onto mat 400, as well as liquids like spilled soft drinks, until the fluids are either evaporated or wiped away.

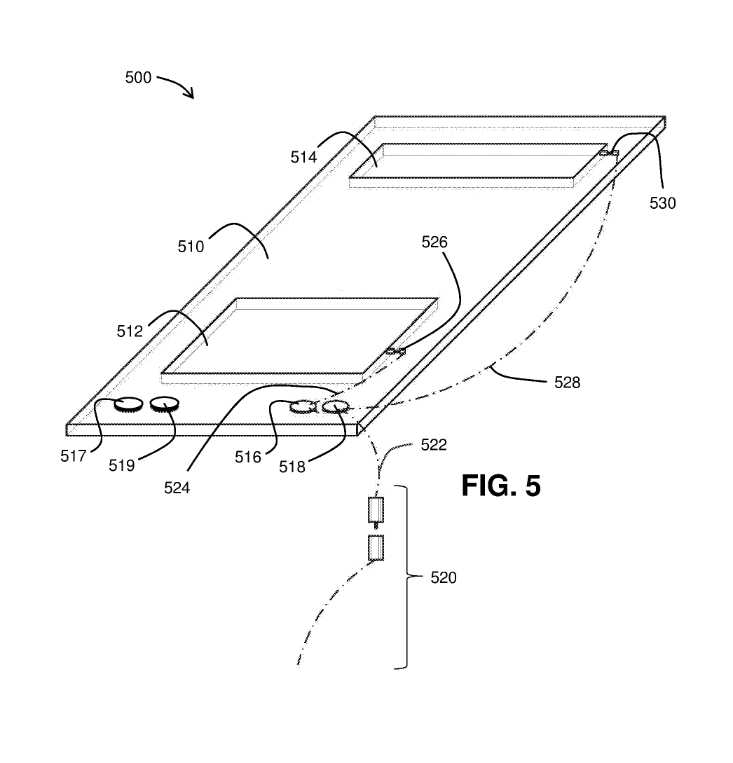

FIG. 5 depicts an illustrative embodiment of a vehicle floor mat 500 with a pair of integral receptacles for receiving and retaining interchangeable functional inserts 512 and 514. Base 510 has an outwardly-facing perimeter surface configured to conform to the contour of the vehicle floor. Base 510 can have a pair of receptacles formed in the upwardly facing surface of base 510. Inserts 512 and 514 can be configured to be received and retained within the receptacle. Inserts 512 and 514 can be removable from and replaceable within their receptacles. In some embodiments, inserts 512 and 514 can have associated electrically powered functionality, as described in more detail below.

As further shown in FIG. 5, electric power source 520 and conductors 522, 524 and 528 supply the electric power to inserts 512 and 514 via plug connectors 526 and 530. Manipulatable switch 517 actuates a first functional modality such as, for example, electrostimulation. Manipulatable switch 519 actuates a second functional modality such as, for example, massage. When use of one of the functional modalities is desired, manipulatable switches 516 and 518 connect and disconnect the electric power to and from one or both of inserts 512 and 514. In at least some embodiments, manipulatable switches 517, 519, 516 and/or 518 can be a depressible foot switch.

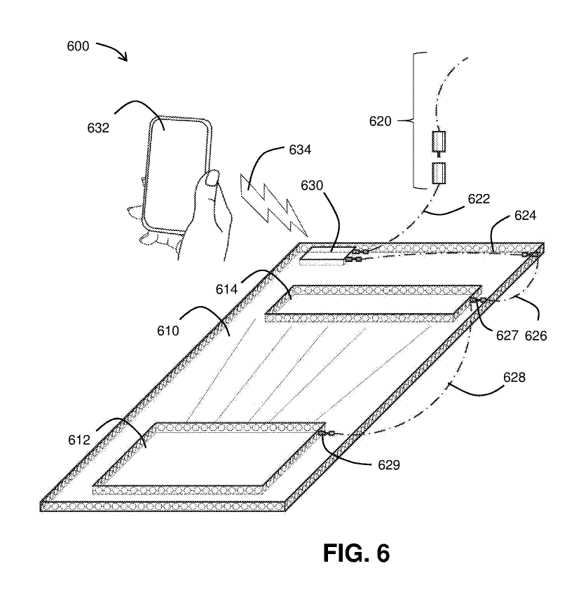

FIG. 6 depicts an illustrative embodiment of a vehicle floor mat 600 with a pair of integral receptacles for receiving and retaining interchangeable functional inserts 612 and 614. Base 610 has an outwardly-facing perimeter surface configured to conform to the contour of the vehicle floor. Base 610 can have a pair of receptacles formed in the upwardly facing surface of base 610. Inserts 612 and 614 are configured to be received and retained within the receptacle. Inserts 612 and 614 are removable from and replaceable within their receptacles. Inserts 612 and 614 have associated electrically powered functionality, as described in more detail below.

As further shown in FIG. 6, a source of electric power 620 and conductors 622, 624 and 628 supply the electric power to inserts 612 and 614 via plug connectors 627 and 629. A microprocessor-based receiver/transmitter 630 can be capable of receiving and transmitting signals wirelessly (see symbol 634) from and to a user device 632. The signals actuate and control the electrically powered functionality associated with inserts 612 and 614.

The present floor mat system has the following potential functionality and aesthetic features associated with the inserts:
Replacements: replace inserts or peel off to a new layer, multi-layer refresh pack;
Logos and images: schools, military, national flags, classic cars, pop culture, celebrities, personal images;
Places of worship: church, synagogue, gathering places;
Sport teams: major and minor league, school, park district;
Industry: corporation, small business;
Military: armed services, Memorial Day, Veterans Day, wounded warrior, honor flight;
Holidays: Christmas, Halloween, July 4th, Valentine's Day;
Nature: seasons, national parks, Niagara Falls, trees, plants, flowers, landscape;
Animals: domestics, wild, endangered species;
Germicides: flea and tick prevention, anti-bacterial; and
Personal care: lotion, foot file, fragrance.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A floor mat comprising:
(a) a base having at least one receptacle formed in the upwardly facing surface of said base;
(b) at least one insert configured to be received and retained within said receptacle, said at least one insert removable from and replaceable within said at least one receptacle; and
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle.

2. The floor mat of claim 1, wherein said at least one receptacle is a pair of receptacles and said at least one insert is a pair of inserts, each of said inserts being configured to be received and retained within one of said receptacles.

3. The floor mat of claim 1, wherein said insert is formed of a porous material capable of being penetrated by a pressurized fluid to flush out extraneous material accumulated on or within the pores of said insert.

4. The floor mat of claim 3, wherein said porous material is a mesh.

5. A vehicle floor mat comprising:
(a) a base having an outwardly-facing perimeter surface configured to conform to the contour of the vehicle floor, said base having at least one receptacle formed in the upwardly facing surface of said base; and
(b) at least one insert configured to be received and retained within said receptacle, said at least one insert removable from and replaceable within said at least one receptacle, said at least one insert having electrically powered functionality associated therewith;
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle;
(d) a source of electric power and conductors to supply the electric power to said at least one insert;
(e) at least one manipulatable switch capable of connecting and disconnecting the electric power to and from said at least one insert.

6. The floor mat of claim 5, wherein said at least one receptacle is a pair of receptacles and said at least one insert is a pair of inserts, each of said inserts configured to be received and retained within one of said receptacles, and wherein said at least one manipulatable switch is a pair of manipulatable switches, each of said switches capable of connecting and disconnecting the electric power to and from one of said inserts.

7. The floor mat of claim 5, wherein said manipulatable switch is one of a depressible foot switch or a slideable foot switch.

8. The floor mat of claim 5, wherein said electrically powered functionality is a massage device.

9. The floor mat of claim 5, wherein said electrically powered functionality is a stimulation device.

10. The floor mat of claim 5, wherein said electrically powered functionality is a heating device.

11. The floor mat of claim 5, wherein said electrically powered functionality is a light-emitting device, wherein said light-emitting device produces a plurality of light emissions that are synchronized with music or other sounds received by said light-emitting device.

12. The floor mat of claim 5, wherein said electrically powered functionality is a sound-producing device.

13. The floor mat of claim 5, wherein said at least one insert having electrically powered functionality associated therewith is removable and capable of operating outside of the vehicle when connected to a source of electric power.

14. A vehicle floor mat comprising:
(a) a base having an outwardly-facing perimeter surface configured to conform to the contour of the vehicle floor, said base having at least one receptacle formed in the upwardly facing surface of said base; and
(b) at least one insert configured to be received and retained within said receptacle, said at least one insert removable from and replaceable within said at least one receptacle, said at least one insert having electrically powered functionality associated therewith;
(c) a gasket strip extending from an inwardly-facing perimeter of said at least one receptacle to cover a portion of an outwardly-facing perimeter of said at least one insert such that a water resistant seal is created between said gasket strip and said at least one insert when said at least one insert is inserted into said at least one receptacle;
(d) a source of electric power and conductors to supply the electric power to said at least one insert;
(e) a microprocessor-based receiver/transmitter capable of receiving and transmitting signals wirelessly from and to a user device, said signals actuating and controlling said electrically powered functionality associated with said at least one insert.

15. The floor mat of claim 14, wherein said electrically powered functionality is a massage device.

16. The floor mat of claim 14, wherein said electrically powered functionality is a stimulation device.

17. The floor mat of claim 14, wherein said electrically powered functionality is a heating device.

18. The floor mat of claim 14, wherein said electrically powered functionality is a light-emitting device, wherein said light-emitting device produces a plurality of light emissions that are synchronized with music or other sounds received by said light-emitting device.

19. The floor mat of claim 14, wherein said electrically powered functionality is a sound-producing device.

20. The floor mat of claim 14, wherein said at least one insert having electrically powered functionality associated therewith is removable and capable of operating outside of the vehicle when connected to a source of electric power.
